(19) United States
(12) Patent Application Publication
(10) Pub. No.: US 2018/0182189 A1
(43) Pub. Date: Jun. 28, 2018

(54) DISPLAYING TARGETED MESSAGES ON DISPLAY SCREENS OF AUTOMATED STORAGE AND RETRIEVAL TERMINALS

(71) Applicant: BELL AND HOWELL, LLC, Durham, NC (US)

(72) Inventors: Ramnath A. Lakshmi-Ratan, Durham, NC (US); Daniel Joseph Noga, Apex, NC (US); Larry Allen Blue, North Potomac, MD (US); Guioulnara Abbaszade, Durham, NC (US); Walter S. Conard, Saratoga Springs, NY (US)

(21) Appl. No.: 15/850,657

(22) Filed: Dec. 21, 2017

Related U.S. Application Data
(60) Provisional application No. 62/439,736, filed on Dec. 28, 2016.

(51) Int. Cl. G07C 9/00

(52) U.S. Cl. CPC G07C 9/00079; G07C 9/00103

(57) ABSTRACT

Automated storage and retrieval terminals are disclosed. In some examples, an automated storage and retrieval terminal includes an electronic access system, a display screen, and a control system. The control system is configured for determining that a user present at the automated storage and retrieval terminal is authorized to access a package from a locker and, in response, causing the electronic access system to provide the user access to the first package. The control system is further configured for displaying, based on user information provided by the user at the automated storage and retrieval terminal or package information stored by the control system as part of storing the first package in the first locker or both, a targeted message for the user on the display screen.

### CROSS REFERENCE TO RELATED APPLICATION

This application claims priority to co-pending U.S. Provisional Patent Application Ser. No. 62/439,736, filed on Dec. 28, 2016, the entire disclosure of which is incorporated by reference herein.

### TECHNICAL FIELD

The subject matter described herein relates generally to automated storage and retrieval terminals. More particularly, the subject matter described herein relates to displaying targeted messages on display screens of automated storage and retrieval terminals.

### BACKGROUND

Package deliveries have grown rapidly over the past 15 years with the rise and proliferation of e-commerce. Purchasing some merchandise used to require a person to leave home and visit a merchant, but can now be accomplished from the comfort of home via the Internet. This continuing growth of e-commerce has resulted in an increasing burden on international shipping companies to deliver the ever growing volume of packages needing delivery. Of particular concern to such companies is the cost associated with the so-called “last mile” of delivery, whereby the delivery person must physically drive to the delivery location specified, stop, and deliver a package. This requires a tremendous amount of person-hours which could be avoided by utilizing centralized local automated parcel storage and retrieval terminals which are now beginning to be deployed on a large scale, especially in dense residential environments such as city-centers and suburban apartment complexes. These automated terminals are further suited for being deployed inside of a retailer in order to streamline picking up orders which are placed via the Internet for immediate pickup in a store.

In the case of serving as a centralized hub for deliveries by one or more shipping carriers, these automated storage and retrieval terminals are equipped with the capability for a shipping carrier employee to assign each parcel a locker of suitable size and to provide the identity of the recipient to the automated terminal for associating the recipient of the package with the particular locker in which the package is stored. This allows the shipping carrier employee to deliver all packages for multiple recipients in a single location, thereby reducing fuel costs and reducing the time necessary to make the same number of deliveries separately. An intended recipient is then informed that the package is ready for pickup and goes to the automated terminal. The user provides sufficient identifying information to prove that they are authorized to retrieve the package and the automated terminal will then provide the user access to the package, such as by remotely opening a locker door or by retrieving the package from within and then presenting the package to the user. In the case of an installation in a retail store for in-store pickup of orders, a retail employee would load the order into the automated terminal, but the automated terminal would otherwise work similarly.

### SUMMARY

The subject matter described herein relates to automated storage and retrieval terminals. In some example embodiments, an automated storage and retrieval terminal includes an electronic access system, a display screen, and a control system. The control system is configured for determining that a user, present at the automated storage and retrieval terminal, is authorized to access and/or pick up a package from a locker and, in response, causing the electronic access system to provide the user access to the first package. The control system is further configured for displaying, based on user information provided by the user, at the automated storage and retrieval terminal or package information stored by the control system as part of storing the first package in the first locker or both, a targeted message for the user on the display screen. This targeted message may, in some embodiments, be displayed on one or more external display units which are separate from, connected to, and in the vicinity of the terminal.

The subject matter described in this specification may be implemented in hardware, software, firmware, or combinations of hardware, software and/or firmware. In some examples, the subject matter described in this specification may be implemented using a non-transitory computer readable medium storing computer executable instructions that when executed by one or more processors of a computer cause the computer to perform operations. Computer readable media suitable for implementing the subject matter described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application specific integrated circuits. In addition, a computer readable medium that implements the subject matter described in this specification may be located on a single device or computing platform or may be distributed across multiple devices or computing platforms.

### BRIEF DESCRIPTION OF THE DRAWINGS

FIG. 1 is a perspective diagram of an example automated storage and retrieval terminal;

FIG. 2 is a block diagram of an example communications environment for the automated storage and retrieval terminal;

FIG. 3 is a block diagram of the example automated storage and retrieval terminal; and

FIG. 4 is a flow chart of an example method for displaying targeted messages on display screens of automated storage and retrieval terminals.

### DETAILED DESCRIPTION

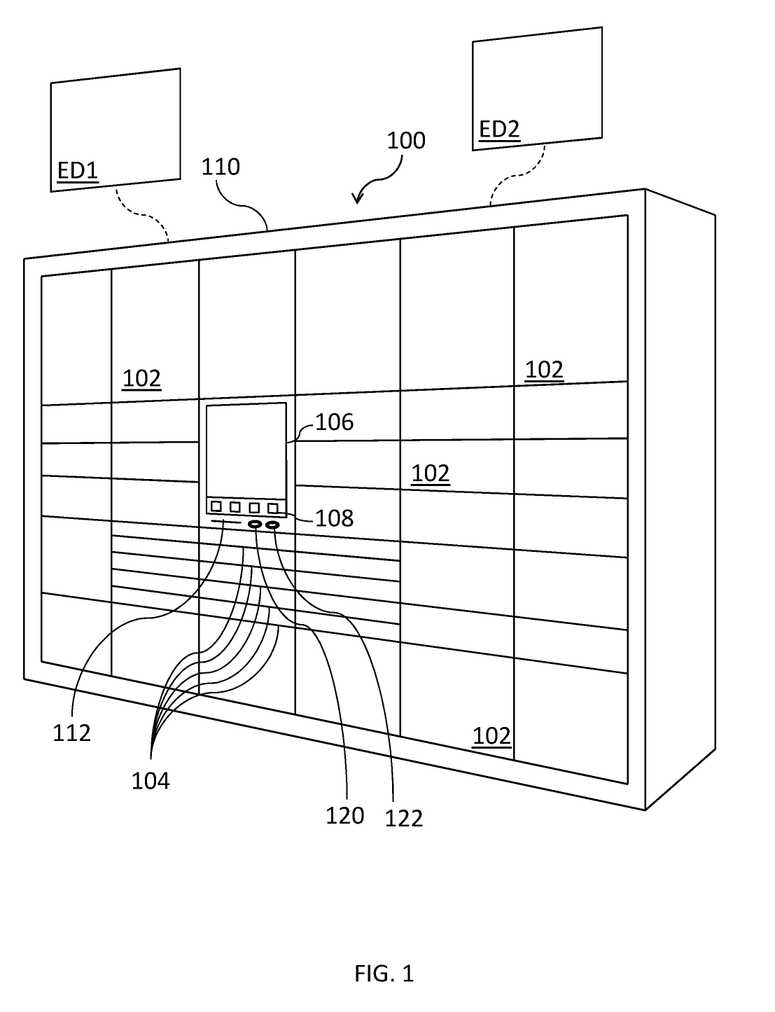

FIG. 1 is a perspective diagram of an example automated storage and retrieval terminal, generally designated 100.

Terminal 100 can be located indoors, outdoors, or any suitable location where packages can be loaded into terminal 100 and the intended recipients can access terminal 100. For example, terminal 100 is suitable to be installed and operated in a retail environment or for use as a delivery hub for one or more shipping carriers for an assigned delivery area. Such terminals 100 may, for example, be referred to as “smart lockers”, which are gaining a foothold in the marketplace for package pick up and/or storage and delivery.

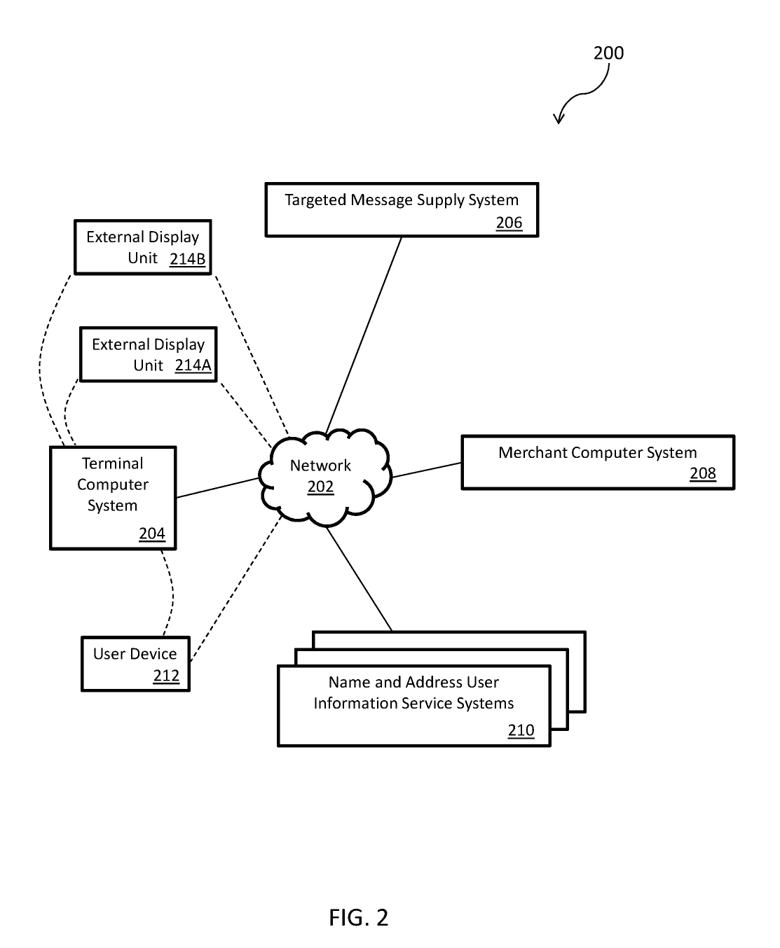

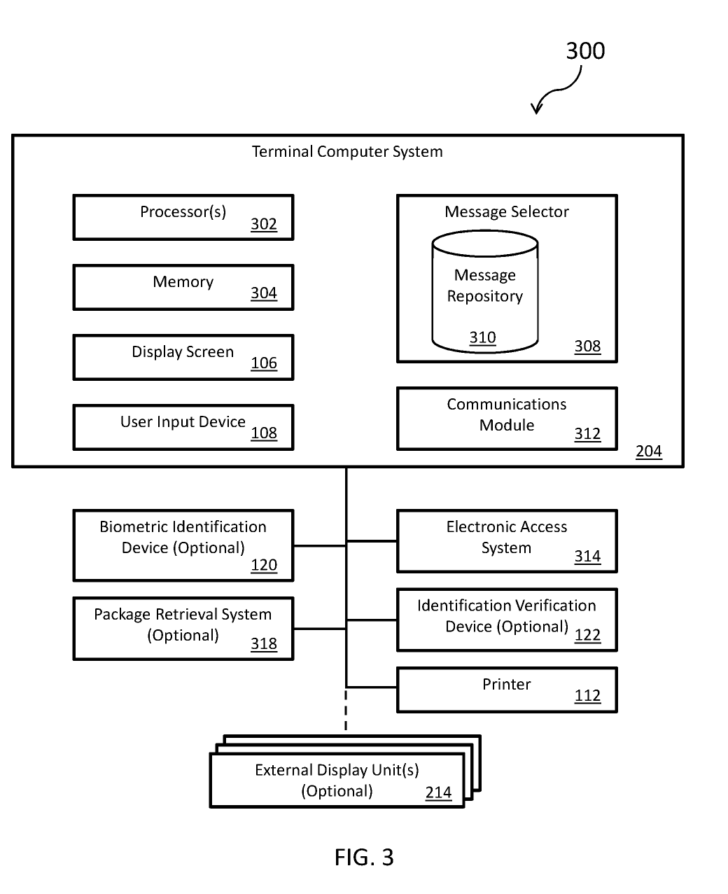

Terminal 100 will typically have a frame which is designed to have suitable strength and durability to handle the packages to be stored and delivered. Additionally, terminal 100 may have a plurality of individual lockers 102 and/or drawers 104 to retrieve packages stored in lockers 102 and/or drawers 104. These lockers 102 and/or drawers 104 may be externally accessible and can be customized to accept larger or smaller items depending on the particular application. Terminal 100 may also have an internal space for storing packages without the need for individual storage compartments such as lockers 102 and/or drawers 104. Terminal 100 can have any combination of externally accessible lockers 102, drawers 104, and/or internally accessible storage spaces. Terminal 100 may also have a display screen 106 and/or external displays ED1 and/or ED2 (see, e.g., external display units 214A and 214B in FIGS. 2 and 3). Terminal 100 may have both display unit 106 and external displays ED1 and ED2. In an alternate embodiment, external displays ED1 and/or ED2 may be provided instead of display unit 106. This may be advantageous because the space occupied by display unit may be replaced by additional lockers 102 and/or drawers 104, as desired, since external displays ED1 and/or ED2, may be installed at a location remote from terminal 100 where it would otherwise be undesirable to locate additional lockers 102 and/or drawers 104 (e.g., above a user's head). Any number of external displays, whether a single external display or a plurality of external displays may be provided without deviating from the disclosure contained herein. Terminal 100 may also only include display screen 106 and not have any external displays.

Terminal 100 has an electronic access system configured to provide authorized users access to one or more of the plurality of lockers 102 to retrieve the packages stored therein. Regardless of the particular configuration of terminal 100, the packages may be robotically retrieved from lockers 102 or drawers 104, robotically retrieved from the internal space of terminal 100, and/or electronically-controlled locks for lockers 102 and drawers 104 may be opened individually (e.g., by temporarily disabling electromagnetic locking devices).

Terminal 100 may further comprise a control system 300 comprising one or more terminal computer systems 204 configured to control electronic access system 314 and to display one or more targeted messages on display screen 106 (see, e.g., terminal computer system 204 of FIG. 2, control system 300, and electronic access system 314 of FIG. 3).

Terminal 100 may also include one or more user input devices 108. As such, the step of determining that the user is authorized to access first locker 102 to retrieve the first package may comprise receiving user input from user input device 108, matching the user input to a first record for the first package in a locker-package database, and determining a location of the first package amongst the plurality of lockers 102 and/or drawers 104 using the first record for the first package in the locker-package database.

According to other embodiments, display screen 106 and user input device 108 can be integrated together in the form of a touchscreen.

As is illustrated in FIG. 1, Terminal 100 may include a printer 112. Printer 112 may be of any suitable type configured to provide a desired printed output, particularly on a piece of paper dispensed to the user of terminal 100. Printer 112 may be configured to provide any type of printed material including, for example, a receipt for package pick up or drop off, coupons for discounted goods and/or services at affiliated retailers, a weather forecast, directions to a specific location (e.g., another terminal where the package is located), etc. Still, in other embodiments, terminal 100 comprises a biometric identification device 120 which is able to use one or more specific biometric identifier of the user (e.g., fingerprint detection, iris scanning, voice recognition, etc.) in order to determine that the user is authorized to access the package. Terminal 100 may also be equipped with an identification verification device 122 capable of detecting some identifying information possessed by the user, such as scanning a two-dimensional visual code on an item provided by the user, wirelessly communicating with a mobile computing device carried by the user, or the like. Biometric identification device 120 and identification verification device 122 may be installed separately, together, or not at all depending upon the security needs for the packages being delivered. If installed together, biometric identification device 120 and identification verification device 122 may be used in a simultaneous or successive manner in order to provide multiple levels of identification verification for the user.

Furthermore, control system 300 may be equipped with one or more sensors and be configured to determine a degree of interaction by the user with the targeted message generated for the user on display screen 106. Examples of such sensors may be cameras configured to detect whether the user is looking at display screen 106, touch sensors, and the like.

In embodiments where a camera is accessible to terminal 100, the camera may be configured to detect and verify a user's identity by using facial recognition algorithms, which are known to those of skill in the art.

FIG. 2 is a block diagram of an example communications environment 200 for an example embodiment of terminal 100. Environment 200 includes a network 202, a terminal computer system 204, a targeted message supply system 206, a merchant computer system 208, one or more name and address user information service systems 210, and, optionally, a user device 212 and/or one or more external display units 214A and 214B.

Network 202 can be any type of appropriate data communications network suitable for exchanging information between terminal computer system 204 and any or all of targeted message supply system 206, merchant computer system 208, name and address user information service systems 210, such as a user database, user device 212, and external display units 214A and 214B.

Terminal computer system 204 may be configured to receive user identification information from, for example, a user input device 108, a biometric identification device 120, an identification verification device 122, and/or the delivery name and/or address as indicated on the package itself (e.g., using optical character recognition (OCR) technology with an image of a label on the package). In some embodiments, user identification information (e.g., package name and/or address information) may be transmitted electronically to terminal computer system 204. In some other embodiments, user identification information may be manually inputted (e.g., typed or scanned) by a person (e.g., a delivery person or merchant employee) present at terminal 100. Once terminal computer system 204 receives the user identification information, it may be configured to do a multitude of different actions depending upon the situation presented.

In a first example where terminal 100 is installed in a centralized location for “last mile” deliveries, terminal computer system 204 may send the user identification information to one or more name and address user information service systems 210 in order to verify the name and/or address of the recipient. This allows for the name and address user information service systems to cross-reference against potential anomalies of the name and/or address, such as aliases and/or misspellings. Name and address user information service systems 210 send one, a subset, or all of the potential names and addresses discovered to terminal computer system 204. Name and address user information service systems may also provide other identifying information about the user, such as an age or age range, a gender, a postal address, a zip code, marital status, whether the user has any dependent children, and the like. In some embodiments, a shipping retailer may place a data source on or within the parcel (e.g., a printed label on the exterior of the parcel or a remote transmitter device inside of the parcel). This data source may, for example, be optically scanned from a label on an external surface of the parcel. According to another example, a passive or active data transmission device (e.g., an RFID tag) may be included inside the parcel. The data source may, among other things, contain user identification information, including the contents and/or recent purchasing history of the recipient of the parcel (e.g., the user at the terminal). This information concerning the contents of the parcel and/or the recent purchasing history may be used to generate customized targeted messages to the user based on known associations between purchasers of a given product and other products which are often purchased along with the product in the parcel.

Still referring to the first example, terminal computer system 204 may then either use the name, address, and/or demographic information received from name and address user information service systems 210 to generate targeted messages from a subset of pre-loaded targeted messages or may submit some or all of the information received from name and address user information service systems 210 to a targeted message supply system 206. For example, if the user is a woman aged 30-35 with a 90210 zip code, that demographic information may be submitted to targeted message supply system 206 via network 202. Targeted message supply system 206 will then generate and send a targeted message to terminal computer system 204 via network 202 to be displayed for the user on display screen 106. Targeted message supply system 206 will generate and deliver the targeted message using the information supplied by terminal computer system 204. Targeted messages may, in some embodiments, be displayed on any display device which is proximate to the user at terminal 100 during parcel retrieval or storage.

In addition to, or instead of, being displayed to the user at display screen 106, the targeted message sent to terminal 100 may be displayed on one or more external display units 214A and 214B in the vicinity of terminal 100 and/or on user device 212. External display units 214A and 214B may have miniature computers running any suitable operating system configured to display graphical content (e.g., a video or still image), either with or without acoustic content accompanying the graphical content; the targeted messages may have either or both of such graphical and acoustic content. The external display units may be of any size and resolution suitable to display the targeted message so as to be readily visible to the user; external display units 214A and 214B may also be located at any location, including a remote location, which would be visible to the user during normal operation of terminal 100. External display units 214A and 214B may be configured to interface directly with terminal computer system 204 and/or network 202 to allow for the targeted message to be communicated to and displayed on external display units 214A and 214B. The targeted message may therefore be displayed on a plurality of display devices, including on display screen 106 and on external display units 214A and 214B. The targeted message may also be displayed on only external display units 214A and 214B, leaving display screen 106 of terminal 100 capable of displaying other content, such as instructions for retrieval or storage of a package associated with the user.

In some embodiments, a user device 212 (e.g., a mobile communication device, such as a smartphone or tablet) associated with and supplied by the user may be used to display such a targeted message, either in conjunction with, or separate from, display screen 106 and external display units 214A and 214B. In some such embodiments, user device 212 communicates directly with terminal computer system 204 in order for targeted messages to be displayed on user device 212; while such communication may be via a direct wired connection, a wireless connection is preferred. In some other such embodiments, the user device may receive targeted messages via network 202. One example of user device 212 being used to display targeted messages may be an instance where the user loads a proprietary application on user device 212 in order to authenticate the user's identity with terminal 100. In such instances, the proprietary application may be configured to display one or more targeted messages, which may be pre-loaded on user device 212 as part of the installation process of the proprietary application in lieu of a transmission of the entire contents of the targeted message from terminal computer system 204 and/or network 202.

Targeted message supply system 206 may be a proprietary system maintained by the owner and/or operator of terminal 100 or it may be operated and maintained by a commercial entity specializing in providing customized targeted messages to users. Furthermore, terminal 100 may analyze one or more sensors to determine a degree of interaction by the user with the targeted message and may further provide this level of interaction to targeted message supply system 206 in order to allow for further optimization of the logic generating the targeted messages by targeted message supply system 206. Where targeted message supply system 206 is operated by a commercial entity, the monetary compensation for the provision of such targeted messages by targeted message supply system 206 may be based on a flat fee, a fee for each targeted message provided, or a fee for a given action taken by the user in response to the targeted message. It is further possible that the operator of terminal 100 may be compensated for allowing such targeted messages to be displayed to the user while at terminal 100.

Referring again to the first example, terminal 100 may further query one or more shipping carrier databases in order to determine whether the user receives packages from a particular merchant or class of merchants frequently. For example, a user may receive numerous packages from a particular merchant, in which case that particular merchant's computer system (e.g., 208) may be queried to generate a targeted message to display to the user. Similarly, a large volume of shipments from a particular class of merchant, for instance from home improvement merchants, may indicate that the user would be receptive to targeted messages for home improvement products. This propensity towards home improvement products may also be provided to targeted message supply service 206 for a targeted message containing particular content, in this instance for home improvement merchants and/or products, to be presented to the user while at terminal 100.

Furthermore, if the package is not currently in terminal 100, terminal computer system 204 may be configured to query, via network 200, a location and/or status of the package.

According to a second example, terminal 100 may be installed, either permanently or on a temporary basis and either indoors or outdoors, at a retail merchant's physical store. In this example, terminal computer system 204 will typically receive the user identification information from merchant computer system 208, because the user ordering the merchandise will provide sufficient information in order for the merchant's billing system to charge the user for the merchandise. Similarly, if the person paying for the merchandise differs from the user picking up the merchandise at terminal 100, the user picking up the merchandise will provide sufficient identifying information about the user for terminal computer system 204 to verify the identity of the user at terminal 100 during pickup. In either case, merchant computer system 208 will typically supply at least the name and address of the user that will be present at terminal 100.

In such a retail installation, terminal computer system 204 can, in some cases, utilize the user identification information to deliver targeted messages relating to other merchandise or services offered for sale by the merchant or to offer targeted messages from other merchants or service providers. While these other merchants or service providers may be direct competitors to the merchant, the typical case will be for affiliated business entities owned by a common corporate conglomerate or for other non-competing merchants.

Where the merchant desires to present one or more targeted messages for its own products or services to the user at terminal 100, merchant computer system 208 will typically analyze the user's purchase in this instance as well as historical purchases and even a user's browsing history to determine which other products or services offered by the merchant the user may be likely to be interested in. For instance, if a user has purchased an electrical outlet, the home improvement merchant's computer system 208 may decide to display a targeted message for wire strippers or other electrical installation tools to the user. Similarly, merchant computer system 208 may be programmed to display a service, such as an installation service provided by the merchant or a third party, which is related to the merchandise ordered by the user.

According to a third example, terminal 100 may have a finite number of targeted ads, e.g., stored in local memory of terminal 100, which terminal 100 is configured to display at any given time. Terminal 100 may then obtain the user demographic information from one or more name and address user information service systems 210 and display a targeted message on display screen 106 without querying targeted message supply system 206. Similarly, terminal 100 may discern the identity of the shipper of the package being retrieved and may be programmed to display a promotional message for the package shipper or even a competitor of the package shipper.

According to a fourth example, a merchant may install a dedicated terminal 100 from which its users can retrieve packages. The method of generating targeted messages is substantially similar to the method described above in the second example.

The above provided examples are not exhaustive and a person of ordinary skill in the art will understand that other possible permutations of displaying targeted messages to a user at a terminal 100 will be within the scope of the subject matter described herein.

Terminal computer system 204 is configured to send information concerning user identification information to targeted message supply system 206, merchant computer system 208, and/or name and address user information service systems 210 via network 202.

FIG. 3 is a block diagram of a control system 300 for example automated storage and retrieval terminal 100.

Control system 300 can have a terminal computer system 204 that can include one or more processors 302, memory 304, a display screen 106, a user input device 108, a message selector 308, and a communications module 312. Memory 304 stores instructions for processors 302 that can be loaded, e.g., into random access memory (RAM), and executed by processors 302 to cause processors 302 to perform operations for providing access to packages and displaying targeted messages. Display screen 106 displays information related to the retrieval of packages from terminal 100 as well as displaying targeted messages. User input device 108 takes user input, typically to allow the user to provide user identification information to verify the user is authorized to retrieve the package.

Communications module 312 is configured to enable terminal computer system 204 to send user identification information to external systems, such as name and address user information services systems 210, targeted message supply systems 206, or merchant computer systems 208. Communications module 312 may be configured to interact wirelessly with a mobile computing device associated with and carried by the user in order to aid in identifying that the user is authorized to access the packages. Communications module 312 may also be configured to communicate with other types of systems and devices. Communications module 312 can have, for example, one or more of a wireless control chip and an antenna or a communications card with communication ports on the card.

Message selector 308 may receive user identification information from one or more external systems, such as those illustrated in FIG. 2, via communications module 312, from user input at user input device 108, and/or from addressing information indicated on the package being stored for retrieval by the user. Message selector 308 selects a message from message repository 310 that correlates with the user information received by the message selector from one or more of the various sources. Where the targeted messages are generated from targeted message supply system 206, message selector 308 is optional and communications module 312 may be configured to deliver the targeted message directly to the one or more processors 302, memory 304, and display screen 106.

Message selector 308 may further have an anonymization module which ensures that sensitive user information is removed before any information about the user is disseminated. Furthermore, message selector 308 may have an encryption module which allows for encryption of any user information sent by terminal 100, whether the user information has been anonymized or not.

All of the targeted messages, whether generated and/or selected locally via message selector 308 or sent from targeted message supply system 206, may comprise any, all, or any combination of a video clip on the display, playing audio for the video clip on an audio speaker (not shown), showing a coupon for which could be either printed or loaded onto a mobile computing device, or the like. The video clip may be news content, weather content, entertainment content, and/or a promotional message targeted to the user. With the identity of the user at terminal 100 known, this identity information may be cross-referenced with other information about the user or even members of the user's household. For example, where a relationship between a user and another person (e.g., a spouse) is known, the previous purchasing information of the spouse may be used to generate targeted messages which are relevant to the user's household needs; this example is best illustrated where terminal 100 is located within and has access to the database of a commercial retailer to cross-reference household purchasing information. The above types of targeted messages and the examples of message content are for purposes of illustration only and are not to be interpreted as limiting the types of targeted messages which may be presented to the user.

Control system 300 may further have one or more of an electronic access system 314, a biometric identification device 120, an identification verification device 122, and a package retrieval system 318.

Biometric identification device 120 is an additional option for increased security of terminal 100. Biometric identification device 120 may have one or more of a fingerprint scanner, a retina scanner, a voice recognition device, or even a touch DNA analysis device. When equipped with biometric identification device 120, control system 300 is equipped to compare a pre-loaded profile of a biometric marker associated with a user against a biometric marker of the user while at terminal 100. A positive comparison result (e.g., a match between the pre-loaded profile and the actual biometric marker) will result in a positive user identification to be indicated to the control system. If the biometric identification result is negative, then the user may still be allowed to attempt to authenticate in some other manner.

According to a further example, a biometric device on a mobile computing device provided by the user may be coupled wirelessly to terminal 100, whether by communications module 312 or by some other device and/or interface, in order to provide a biometric identification of the user. In this way, the mobile computing device is already programmed to recognize one or more biometric marker of the user and is able to authenticate the user's identity to terminal 100 via a wireless protocol (e.g., BLUETOOTH®), thereby providing enhanced identity protection for the user because the user's biometric markers need not be loaded into the memory of terminal computer system 204.

For example, a mobile computing device can be configured to verify a biometric marker from a user by a fingerprint reader on a smartphone. Smartphones equipped with fingerprint readers can detect and verify a user's fingerprint and then wirelessly transmit an authentication of the fingerprint to terminal 100 via many paths, one of which may involve a unique application loaded on the smartphone. This remote processing of the user's fingerprint on a mobile computing device enhances user identity security because the user's fingerprint need not ever be loaded on another device, such as terminal 100, in order for terminal 100 to provide access to an authenticated user.

Identification verification device 122 may have one of a multitude of various commercially available devices used to detect the presence of some object or code that was only sent to or otherwise made available to the user. Examples of such devices are RFID sensors, optical scanners capable of optically scanning a two-dimensional visual code on an item provided by the user, and the like. The use and implementation of these devices in authenticating a verified user is well known in the art and will not be discussed further herein.

Electronic access system 314 can be any appropriate electromechanical system for remotely providing access to the drawer and/or locker where the package is being stored by terminal 100. Electronic access system 314 preferably receives a command from control system 300 indicating a positive identification authentication of the user at terminal 100 which then causes electronic access system 314 to cause the appropriate locker 102 or drawer 104 to be accessed by the user. Examples of devices which may be employed in controlling access to the packages may be electromagnets, electromechanical locking devices, and the like. It is also possible for electronic access system 314 to be entirely mechanically controlled via a system of mechanical linkages, pneumatics, and the like.

Package retrieval system 318 may be employed in addition to or wholly in place of the externally accessible lockers 102 and/or drawers 104 illustrated in FIG. 1. Package retrieval system 318 may employ an internal robotic system which has access to an internal space within terminal 100 which is not typically externally accessible. The internal space may be configured to have a plurality of sub-spaces which can either be of fixed dimensions or configured by terminal 100 to accommodate any of a variety of package shapes based on a present demand. Package retrieval system 318 is configured to travel to a location pre-stored in memory 304 of terminal 100 within the internal space where the package is being stored, extract the package, transfer the package to an externally accessible area, and present the package to the user for retrieval.

Once the user input has been received from user input device 108, biometric identification device 120, and/or identification verification device 122, control system 300 compares this user input to a first record for a package in a locker-storage database stored in memory 304. Control system 300 then determines a location of the package amongst lockers 102, drawers 104, and/or the internal space using the first record for the package in the locker-package database.

The example terminal 100 is configured to receive packages, regardless of where terminal 100 is installed, from either an employee of the shipping company or from an employee of the store where terminal 100 is installed. The shipping company employee or store employee will indicate that packages will need to be stored for final retrieval by the recipient or another person to retrieve the package for the recipient. After initiating the loading process, the dimensions and shipping information, such as name and address, of each recipient must be input into terminal 100, typically by using an optical scanner to read a two-dimensional barcode or QR code printed on the shipping label. Control system 300 will then allocate an available locker 102 or drawer 104 of sufficient size to accommodate the package. The size of the package could also be detected by terminal 100, itself. Control system 300 will then remotely release locker 102 or drawer 104, which is now allocated to store the package therein. The shipping carrier employee or store employee will then insert the package and close the door, which control system 300 will secure. The loading process will then continue until all packages to be stored have been loaded into terminal 100 for storage.

Regardless of whether the user at terminal 100 is the intended recipient or a person otherwise authorized to retrieve the package, terminal 100 will receive sufficient identifying information from the shipping carrier or merchant computer system to be able to sufficiently authenticate the identity of the user at terminal 100.

It is also possible for the package information stored by control system 300 as part of the process of storing the package in the first locker to contain recipient information for the package stored in the first record for the package in the locker-package database. Examples of such recipient information are the recipient name, postal address and/or zip code. It is therefore possible for the targeted message to be displayed to be selected based on such recipient information.

It is further possible for terminal 100 to accept packages from users, and not just from shipping carrier employees. In such a case, the user may be prompted upon arriving at terminal 100 whether the user is picking up or dropping off a package in terminal 100. It may be necessary for the user to input some information for the package manually via either user input device 108 or through an integrated touchscreen (not shown). Alternatively, the user may have a pre-printed shipping label with a barcode affixed to the package that can be optically scanned by terminal 100.

Other possible ways of transmitting shipping information for the package to terminal 100 may include, for example, an RFID device, wireless communication with a mobile computing device, or the like. Any and/or all of these may be employed to allow the user to avoid manually entering the shipping information into user input device 108, thereby improving a user's satisfaction with using terminal 100 for returning packages. It is also possible for terminal 100 to accept packages with pre-printed shipping labels from users, thereby allowing users to avoid making separate trips to the shipping carrier locations. In any instance, whether making returns or shipping new packages, terminal 100 will obtain various user identification information and can use this information to generate targeted messages to the users in the same or a similar manner to that described above for users retrieving packages from terminal 100.

The systems and components described above are non-exhaustive examples and are not to be interpreted to be limiting. Furthermore, these systems and components may be configured in any possible combination to define an automated storage and retrieval terminal 100 capable of displaying targeted messages to a user.

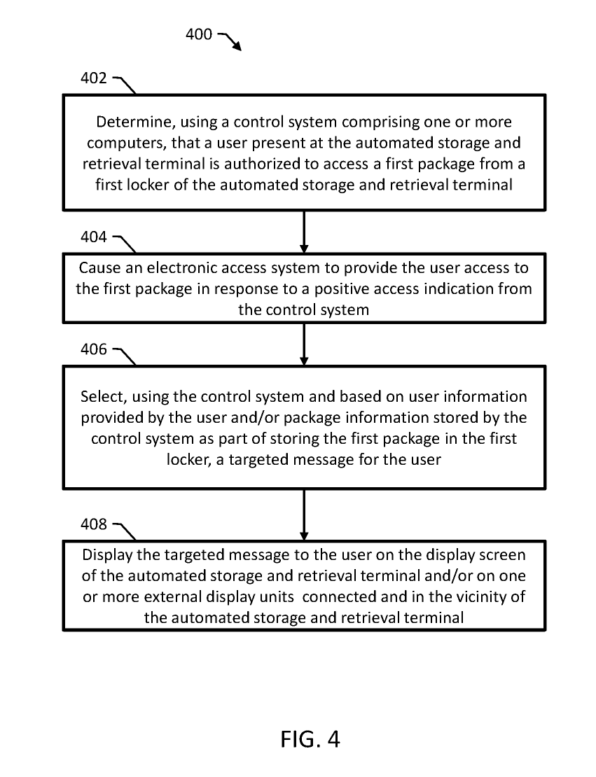

FIG. 4 is a flow chart of an example method 400 for displaying targeted messages on display screens 106 of an automated storage and retrieval terminal (e.g., terminal 100). Method 400 is performed by a system of one or more computers configured, by virtue of appropriate programming, to identify a user at terminal 100 and display, on a display screen 106 of terminal 100, a targeted message selected based on the user. For example, terminal 100 in FIG. 1 can perform method 400.

In block 402, a control system (e.g., control system 300) of terminal 100, control system 300 comprising one or more computers, is used to determine whether a user present at terminal 100 is authorized to access a first package from a first locker of terminal 100.

In block 404, a positive access indication from control system 300 causes an electronic access system of terminal 100 to provide the user access to the first package.

In block 406, control system 300 selects, based on user information provided by the user and/or package information stored by control system 300 as part of storing the first package in the first locker, a targeted message for the user.

In block 408, the targeted message is displayed to the user on display screen 106 of terminal 100 and/or on one or more external display units (e.g., 214A and 214B) connected to and in the vicinity of terminal 100.

Accordingly, while the methods, systems, and computer readable media have been described herein in reference to specific embodiments, features, and illustrative embodiments, it will be appreciated that the utility of the subject matter is not thus limited, but rather extends to and encompasses numerous other variations, modifications and alternative embodiments, as will suggest themselves to those of ordinary skill in the field of the present subject matter, based on the disclosure herein.

Various combinations and sub-combinations of the structures and features described herein are contemplated and will be apparent to a skilled person having knowledge of this disclosure. Any of the various features and elements as disclosed herein may be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

It is understood that various details of the presently disclosed subject matter may be changed without departing from the scope of the presently disclosed subject matter. Furthermore, the foregoing description is for the purpose of illustration only, and not for the purpose of limitation.

### REFERENCE NUMBER LIST

100—Automated Storage and Retrieval Terminal
102—Locker
104—Drawer
106—Display Screen
108—User Input Device
110—Frame
112—Printer
120—Biometric Identification Device (Optional)
122—Identification Verification Device (Optional)
200—Communications Environment
202—Network
204—Terminal Computer System
206—Targeted Message Supply System
208—Merchant Computer System
210—Name and Address User Information Service Systems
212—User Device
214—External Display Unit(s) (Optional)
214A—External Display Unit
214B—External Display Unit
300—Control System
302—Processor
304—Memory
308—Message Selector
310—Message Repository
312—Communications Module
314—Electronic Access System
400—Method (with blocks 402 to 408)

What is claimed is:

1. An automated storage and retrieval terminal comprising:
an electronic access system configured to provide an authorized user access to one or more of a plurality of lockers to retrieve packages stored in the lockers by robotically retrieving packages from the lockers, robotically retrieving packages from an internal space of the terminal, and/or individually opening electronically-controlled doors for the lockers;
a display screen; and
a control system comprising one or more computers configured to control the electronic access system and display targeted messages on the display screen by:
determining that a user present at the automated storage and retrieval terminal is authorized to access a first package from a first locker and, in response, causing the electronic access system to provide the user access to the first package; and
displaying, based on user information provided by the user at the automated storage and retrieval terminal or package information stored by the control system as part of storing the first package in the first locker or both, a targeted message for the user on the display screen.

2. The terminal of claim 1, further comprising a user input device,
wherein determining that the user is authorized to access the first locker to retrieve the first package comprises:
receiving user input from the user input device;
matching the user input to a first record for the first package in a locker-package database; and
determining a location of the first package amongst the plurality of lockers using the first record for the first package in the locker-package database.

3. The terminal of claim 2, wherein the display screen and the user input device are integrated as a touchscreen and wherein receiving the user input comprises:
displaying a prompt on the touchscreen for the user to supply identification; and
receiving a user identifier from the touchscreen.

4. The terminal of claim 2, wherein receiving the user input comprises one or more of:
identifying the user using a biometric identification device;
optically scanning a two-dimensional visual code on an item provided by the user using an identification verification device; and
wirelessly communicating with a mobile computing device carried by the user using the identification verification device.

5. The terminal of claim 2, wherein the user information provided by the user at the automated storage and retrieval terminal comprises a user identifier, and wherein displaying the targeted message for the user on the display screen comprises selecting the targeted message based on user demographic information associated with the user identifier in a user database.

6. The terminal of claim 5, wherein the user demographic information comprises one or more of:
an age and/or gender of the user;
a postal address and/or zip code of a residence associated with the user; and
information specifying whether the user has dependent children.

7. The terminal of claim 2, wherein the package information stored by the control system as part of storing the first package in the first locker comprises recipient information for the first package stored in the first record for the first package in the locker-package database, and wherein displaying the targeted message for the user on the display screen comprises selecting the targeted message based on the recipient information.

8. The terminal of claim 7, wherein the recipient information comprises a recipient name, a recipient postal address, and/or a zip code.

9. The terminal of claim 1, wherein displaying the targeted message for the user on the display screen comprises displaying a video clip on the display screen and playing audio for the video clip on an audio speaker, wherein the video clip comprises news, weather, entertainment, or a promotional message targeted to the user.

10. The terminal of claim 1, wherein the control system comprises one or more sensors and is configured to determine a degree of interaction by the user with the targeted message generated for the user on the display screen.

11. The terminal of claim 10, wherein the one or more sensors comprises a camera configured to verify the user's identity via facial recognition.

12. The terminal of claim 1, comprising one or more external display units, which are in electronic communication with, and in a vicinity of, the terminal, wherein the targeted message for the user is displayed on the one or more external display unit.

13. The terminal of claim 1, comprising a printer configured to provide a printed output to the user at the terminal.

14. A method for displaying targeted messages on a display screen of an automated storage and retrieval terminal, the method comprising:
determining, using a control system of the automated storage and retrieval terminal comprising one or more computers, that a user present at the automated storage and retrieval terminal is authorized to access a first package from a first locker of the automated storage and retrieval terminal;
causing an electronic access system to provide the user access to the first package in response to a positive access indication from the control system;
selecting a targeted message for the user using the control system, wherein selecting a targeted message is based on user information provided by the user and/or package information stored by the control system as part of storing the first package in the first locker; and
displaying the targeted message to the user on the display screen of the automated storage and retrieval terminal.

15. The method of claim 14, wherein determining that the user is authorized to access the first locker to retrieve the first package comprises:
receiving user input from a user input device;
matching the user input to a first record for the first package in a locker-package database; and
determining a location of the first package amongst the lockers using the first record for the first package in the locker-package database.

16. The method of claim 15, wherein the display screen and the user input device are integrated as a touchscreen and wherein receiving the user input comprises:
displaying a prompt on the touchscreen for the user to supply identification; and
receiving a user identifier from the touchscreen.

17. The method of claim 15, wherein receiving the user input comprises one or more of:
identifying the user by a biometric identification device;
optically scanning a two-dimensional visual code on an item provided by the user; and
wirelessly communicating with a mobile computing device carrier by the user.

18. The method of claim 15, wherein the user information provided by the user comprises a user identifier and wherein displaying the targeted message for the user on the display screen comprises selecting the targeted message based on user demographic information associated with the user identifier in a user database.

19. The method of claim 18, wherein the user demographic information comprises one or more of:
an age and/or a gender of the user;
a postal address and/or zip code of a residence associated with the user; and
information specifying whether the user has dependent children.

20. The method of claim 15, wherein the package information stored by the control system comprises recipient information for the first package stored in the first record for the first package in the locker-package database and wherein displaying the targeted message for the user on the display screen comprises selecting the targeted message based on the recipient information.

21. The method of claim 20, wherein the recipient information comprises a recipient name, a recipient postal address, and/or a zip code.

22. The method of claim 14, wherein displaying the targeted message for the user on the display screen comprises displaying a video clip on the display screen and playing audio for the video clip on an audio speaker, wherein the video clip comprises new, weather, and/or a promotional message targeted to the user.

23. The method of claim 14, wherein the control system comprises one or more sensors and is configured to determine a degree of interaction by the user with the targeted message generated for the user on the display screen.

24. The method of claim 14, wherein displaying the targeted message to the user comprises displaying the targeted message on the display screen of the automated storage and retrieval terminal and/or one or more external display units, which are in electronic communication with, and in a vicinity of, the terminal

25. The method of claim 23, wherein determining that the user present at the automated storage and retrieval terminal is authorized to access the first package comprises using facial recognition via a camera.

26. The method of claim 14, comprising printing, via a printer, an printed output for user based on a transaction of the user at the automated storage and retrieval terminal.

27. One or more non-transitory computer readable media storing instructions for at least one processor that, when executed by the at least one processor, cause the at least one processor to display targeted messages on a display screen of an automated storage and retrieval terminal by:
determining that a user present at the automated storage and retrieval terminal is authorized to access a first package from a first locker of the automated storage and retrieval terminal and, in response, causing an electronic access system to provide the user access to the first package;
selecting, by the control system and based on user information provided by the user at the automated storage and retrieval terminal or package information stored by the control system as part of storing the first package in the first locker or both, a targeted message for the user; and
displaying, on the display screen of the automated storage and retrieval terminal, the targeted message to the user.
